(19) United States
(12) Patent Application Publication
(10) Pub. No.: US 2018/0037101 A1
(43) Pub. Date: Feb. 8, 2018

(54) Easily applied extend-able and fold-able removable apparatus for vehicle surface protection

(71) Applicant: Douglas Dick, Venice, CA (US)

(72) Inventor: Douglas Dick, Venice, CA (US)

(21) Appl. No.: 15/227,415

(22) Filed: Aug. 3, 2016

(51) Int. Cl. B60J 11/06; B60J 3/00; B60R 13/04

(52) U.S. Cl. CPC B60J 11/06; B60R 13/04; B60J 3/002

(57) ABSTRACT

An improved unique and distinguishable removable protection apparatus for steel exterior vehicle surfaces comprised of an integral single unit multi panelized nonabrasive lightweight and flexible impact absorbing sheet material that is easily applied, quickly foldable, stow able and is configured to be releasably applied to a vehicle's surfaces by means of a plurality of magnets such that the apparatus is substantially disposed in a plurality of positions thereby protecting a parked vehicle's finish, it's surface condition and even its windows from dings, scratches and blemishes caused by impact of foreign objects. The apparatus includes an advantageous unique inbuilt hinge system that urges the multi panelized apparatus to easily extend or fold accordion like due to the flexible spring back nature of the impact absorbing sheet material.

### BRIEF DESCRIPTION OF PRIOR ART

Various types of exterior vehicle door and surface protectors and door guards in prior art have been devised for attempting to solve the aforementioned problem. For example, of reference; U.S. Pat. No. 8,746,762 B2, U.S. Pat. No. 5,312,145 A, U.S. Pat. No. 8,702,136 b2, US 20070278804 A1, US 20080012362 A1, U.S. Pat. No. 6,254,170 B1, and U.S. Pat. No. 6,769,725 B2.

However, in sum, all suffer some serious disadvantages and deficiencies. Prior inventions in the nature of exterior vehicle protectors, door guards and the like are considered by me to be bulky, awkward, heavy, difficult to attach remove and stow, not practical or cost effective to produce. More specifically some prior art uses tethers, cords, hooks and straps and suction cups to secure the device to a vehicle, but during an attempted theft, the vehicle itself would inevitably be damaged. Others require modifications to the vehicle and others simply do not substantially protect the most vulnerable areas of a vehicle's surfaces. While all strive to serve a basic function I believe they are uniformly deficient with respect to their failure to provide a simple, efficient and practical device that substantially protects a vehicle's exterior surfaces.

Consequently, there is a longstanding need for a new and improved unique and distinguishable exterior vehicle protection apparatus such as the one or more aspects of the present apparatus in the ensuing description and accompanying drawings. Indeed, heretofore unknown in prior art, the provided apparatus' various aspects fill the need for a more comprehensive, cost efficient to produce, easily deployed, simple, lightweight, uniquely openable, foldable and stow able device that succeeds where others have failed to be convenient, easy to use, resilient, effective, ergonomic and aesthetically pleasing. Also, the provided apparatus practically folds itself and effortlessly releasably deploys in seconds due to a unique and novel arraignment of one or more beneficial aspects of this apparatus. Subsequently, the previously stated, and other, benefits of one or more aspects of my protector for vehicle's exterior steel surface's will become apparent from a consideration of the ensuing description, details and accompanying drawings that may produce an unobvious advantage over prior art.

### BACKGROUND OF INVENTION

Modern vehicles like cars, trucks and recreation vehicles are subject to a barrage of dings, dents, scratches and blemishes caused by impact of any dense object. Today, everyone is in a hurry and there is an air of irresponsibility and belligerence amongst vehicle owners and vandals than ever before. Chief violators are flung open car doors, shopping carts, bicycles, scavenger's carts, garden equipment and persons carrying unwieldly purchases from big box stores. Other key trends contribute to increased propensity for reckless behaviors that cause damage to a vehicle's surfaces, like, longer vehicle doors with greater swings, lack of standard moldings and larger longer vehicles and shorter narrower parking stalls. Consequently, there is a longstanding need for a solution to the aforementioned problems.

### FIELD OF INVENTION

This field relates to exterior vehicle surface protection.

### SUMMARY OF INVENTION

One or more aspects provided in the description and drawings provide an improved unique and distinguishable removable protection apparatus for steel exterior vehicle surfaces comprised of a single multi panelized integral nonabrasive lightweight and flexible impact absorbing material that is easily applied, foldable, stow able and is configured to be releasably applied on steel bodied surfaces by means of a plurality of magnets such that the apparatus is substantially disposed in a plurality of positions thereby protecting a parked vehicle's finish and surface condition from dings, scratches and blemishes caused by impact of foreign objects. Various aspects of the apparatus include a unique inbuilt hinge system that impels the single unit multi panelized apparatus to easily releasably extend or fold accordion like due to the flexible spring back nature of its impact absorbing material.

The present invention provides effective vehicle protection.

The present invention is easily quickly disposed.

The present invention is easily removable, foldable and securely stow able. The present invention can be modified and customized for any steel surfaced vehicle. It's simple and affordable for average consumers. It's easily and quickly manufactured.

The value and advantages of this invention will become evident in the detailed descriptions, drawings and embodiments

The present invention becomes attractive to anyone who wishes to protect the exterior of their car, sun shield the interior, provide privacy in their car, advertise something or express themselves to others.

### DESCRIPTION OF SEVERAL VIEWS OF THE DRAWINGS

The accompanying drawings are included to provide a further understanding of the invention and are incorporated into and constitute a part of the specification. They illustrate one embodiment of the invention and together with the description serve to explain the principles of the invention.

FIG. 1 In this general view is an elevation of the present invention deployed to one side of a pictorial illustration of a motor vehicle. It includes a reference to expanded view FIG. 6A

FIG. 2 Is an elevation of the present invention including a reference to expanded view FIG. 7A.

FIG. 3 End view of folded and strapped present invention.

FIG. 4 Overhead view showing movement of present invention opening midstream between folded and fully expanded.

FIG. 5 Perspective view of folded and strapped present invention.

FIG. 6A Expanded view of hinge cut configuration 2 with perpendicular vertical through cuts 7 and horizontal hinge cut configuration through cuts 8.

FIG. 7A Enlarged perspective view of edge and panel face 1, hinge cut configuration 2 which illustrates continuous uncut tab.

### DESCRIBE IMPROVEMENT NOVEL HINGE CUT CONFIGURATION

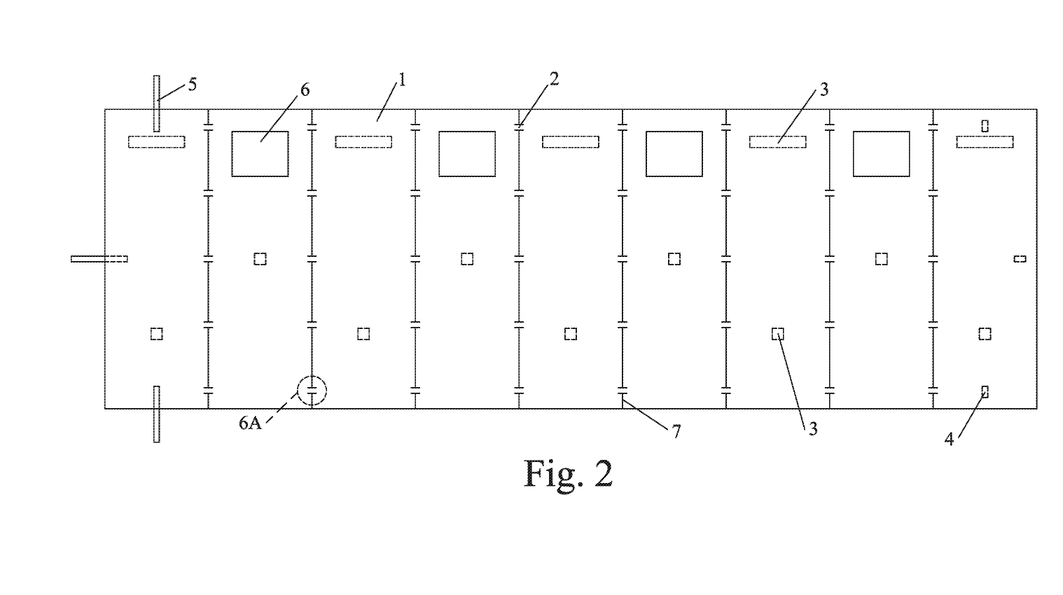

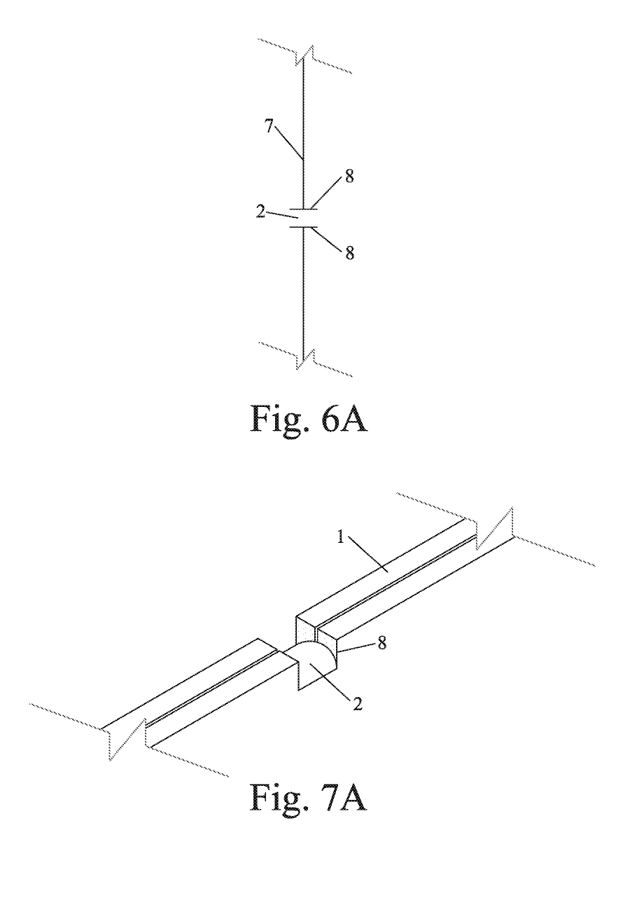

An improvement over prior art is illustrated FIG. 2 in one embodiment of the apparatus. Referring to FIG. 2 are a plurality of predetermined segmented vertical through cuts 7 equally spaced longitudinally from left to right in the single unit spring back natured impact absorbing sheet material 1. The vertical segmented through cuts 7 terminate at the point 8 they perpendicularly intersect the hinge cut configuration FIG. 6A, FIG. 7A, 2 that are equally spaced along and in line with the segmented vertical through cuts 7. The efficacious hinge cut configuration FIG. 6A synergistically functions with the segmented vertical through cuts 7 and the single unit spring back natured impact absorbing sheet material 1 to produce an improved unique aspect of this apparatus that distinguishes it from prior art.

### DETAILED DESCRIPTION OF INVENTION

The following First Embodiment as exemplified by the drawing is illustrative of the invention and is not intended to limit the invention as encompassed by the claims of this application. An apparatus and method for protection of a vehicles exterior steel surfaces is disclosed herein, including the advantages and novelty.

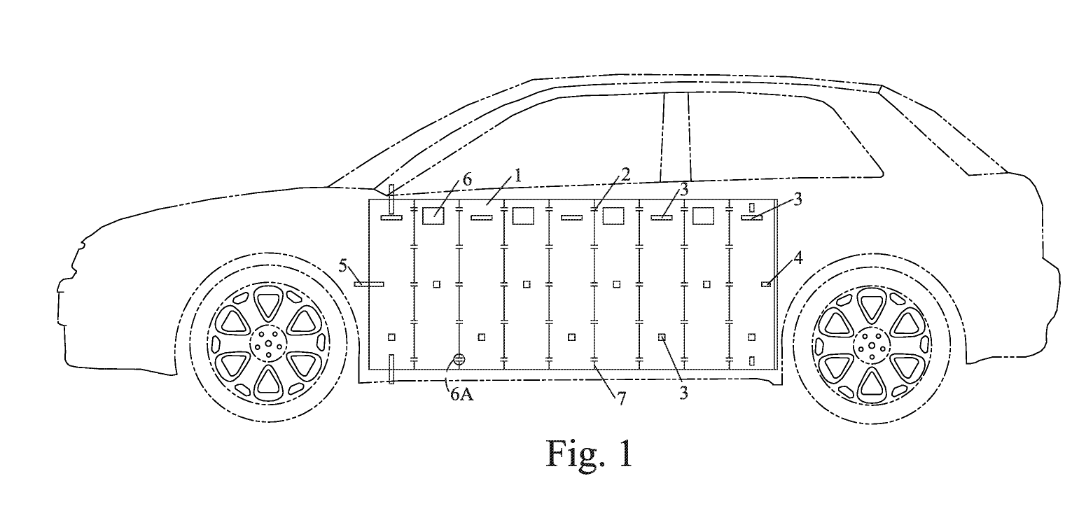

The First Embodiment of the present invention is illustrated in drawings FIG. 1 through 7A.

FIG. 1 illustrates the First Embodiment of the invention comprising a single unit, multi panelized, integrally hinged, impact absorbing spring back natured sheet material 1 extended and disposed longitudinally to an exterior steel surface of a vehicle.

A significant feature of the invention FIG. 1 is the single unit, multi panelized, integrally hinged, impact absorbing spring back natured sheet material 1 that is made panelized by a plurality of segmented inline vertical through cuts 7 that are predeterminedly evenly spaced longitudinally from left to right, which separates each panel except at the hinge cut configuration FIG. 1, FIG. 6A, FIG. 5 and FIG. 7A wherein a tab of impact absorbing spring back natured sheet material 1 remains whole and uncut. Thus, a hinge cut configuration FIG. 6A is created and inbuilt to the single unit, multi panelized, integrally hinged, impact absorbing spring back natured sheet material 1, thereby producing a novel, advantageous and improved hinged folding apparatus as presented.

Another significant feature of the invention FIG. 1 is that it is disposed to the illustrated vehicle's steel surface by flexible magnets 3 illustrated by dashed lines that are fixedly bonded to the apparatus's back side in an evenly spaced configuration.

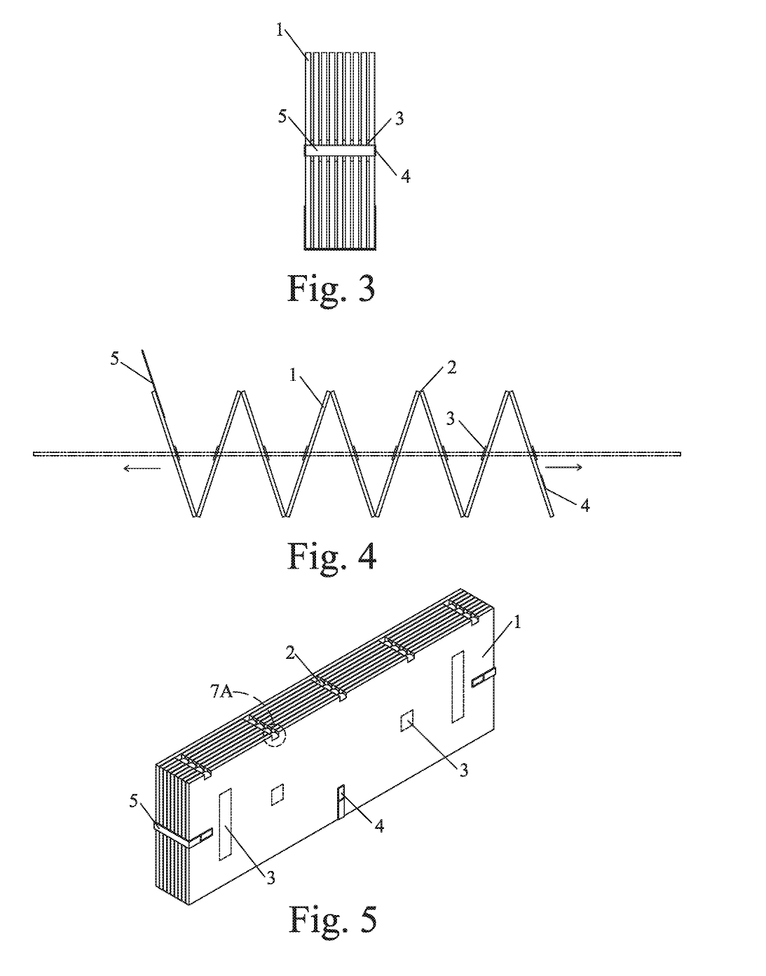

Binding fasteners comprised of a hook tab 4 and a loop strap 5, commonly known as a hook and loop fastener, securely bind the folded apparatus FIG. 3 and FIG. 5 for the stow position.

A plurality of Graphic Visual Alert Areas FIG. 2, 6 are spaced evenly longitudinally near the top of the apparatus 1.

### Additional Embodiments

In another Embodiment a denser foam product with a stronger pound tolerance can be used and would require stronger magnets.

In an additional Embodiment, the invention may have pockets to hold and display brochures and business cards.

In another Embodiment, at the user's whim they may deploy the apparatus over a vehicle's windows, or high up on a vehicle to use for sun shield, privacy, advertising, messaging, etc. to others.

An additional Embodiment of this invention, the entire apparatus FIG. 2 can be easily cut and shaped into smaller independent units that have some of the same attributes and qualities as the First Embodiment in that the smaller units can be releasably disposed anywhere on a vehicle's steel surface, can be imprinted with art, messaging, advertising, logos, marketing information and all manner of graphics.

This same Embodiment can be pre-scored during manufacture to delineate advantageous cutting and shaping of the original First Embodiment's size to be utilized most efficaciously to the general consumer. For instance, the original First Embodiment FIG. 2 can be pre-scored in half both vertically or longitudinally thereby producing two equal units to be utilized on each side of a vehicle.

### Use and Operation of Invention

In use and operation of the First Embodiment of this invention there are novel advantages disclosed in the following descriptions. The operation of the present invention is best described by beginning with the folded stacked and strapped compact position FIG. 3 and FIG. 5. When the binding loop strap 5 is released from the hook tab 4 and gentle manual activation initiates the folded apparatus 3 to open, the spring back natured sheet material 1 urges the apparatus FIG. 4 to be almost effortlessly releasably disposed accordion like anywhere to a vehicle's exterior steel surface. The apparatus's nonabrasive magnet's 3 magnetic fields attracting force urges the apparatus FIG. 1 to gently seek and secure itself to a vehicle's steel surface. Then the user can orient the apparatus FIG. 1. anywhere to their liking. To easily remove, fold and stow the apparatus a person user lightly pinches together in their fingertips two areas along the top edge of the apparatus then gently peels away the apparatus towards them disengaging the nonabrasive magnets 3 allowing the apparatus to be urged to fluently spring back to its folded position FIG. 3. The person user then quickly fastens the binding fastener loop strap 5 to the hook tab 4 then compactly stows the apparatus. Alternatively, the user can use only one hand to grab either the first panel's vertical edge end or the last panel's vertical edge end and easily peel away from the vehicle.

### Regarding Details of Materials Used in the Invention

The impact absorbing spring back sheet material 1 preferably is cross linked polyethylene foam of at least a density of 2 pounds and a thickness of ¼″, which performs exceptionally well when die cut with force of a steel press or the like. The cross linked polyethylene foam is hydrophobic, mildew resistant, flexible, has spring back characteristic, multiple densities, multiple colors, lightweight, nonabrasive and a smooth surface conducive to applying screen print, paint, decals, inks and sticky backed tapes and can be personalized creatively and feature company logos, marketing information including real estate ads and business signs and all manner of graphics. The preferred magnets 3 are at least 0.060 thickness, high energy, flexible, nonabrasive and anisotropic with 1.4 MGOe.

Other attachment means such as suction cups and static charged materials may alternatively be used to dispose and secure the present invention to a vehicle other than steel, for instance aluminum and fiberglass, plastic or other composite materials.

### Regarding the Manufacture of the Invention

A preferred manufacturing process includes a predeterminedly sized die cut made for a steel press or the like which can with one single press cut action create panels and a plurality of hinge cut configuration FIG. 6A in a sheet or roll of impact absorbing spring back natured sheet material 1. Thus, producing a single unit apparatus FIG. 2 including inbuilt panels and hinges. The manufacture of the invention is completed by simply fixedly bonding flexible magnets 3, binding fastener loop straps 5 and hook tabs 4, and imprinting graphic alerts to the graphic alert areas 6.

### CONCLUSION AND SCOPE OF INVENTION

Today's popular cultural is less considerate of other's personal property, specifically automotive vehicles. Simultaneously people scream out for a never ending means of personal expression, self-promotion, displays of creativity as well as business promotion and marketing. Yet today, as before, we proudly own vehicles with thinner more vulnerable exterior surfaces that are expensive to maintain and emotionally draining to see abused and ruined by others. That's why this invention is excitingly timely, perfunctorily effective and satisfies the needs of personal expression all in one simple apparatus.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An apparatus to protect a vehicle's exterior steel surfaces, comprising:
an integral substantially predeterminedly sized single unit multi panelized integrally hinged, spring back natured sheet material;
includes a plurality of a unique inbuilt hinge cut configuration that novelty act in conjunction with said spring back natured sheet material, thereby urging said multi panelized aspect of said apparatus to advantageously easily deploy and fold for compact storage.
further included a plurality of predeterminedly sized magnets fixedly disposed to the back of the said single unit multi panelized, integrally hinged, spring back sheet material as a means to attach the said apparatus to a vehicle's steel exterior surfaces; and
hook and loop straps that bind the said apparatus in the folded stow position

2. The protection apparatus of claim 1, wherein the said apparatus can be deployed over a vehicle's windows and openings that are contiguous to and surrounded by a vehicle's steel surfaces, whereby the said apparatus is utilized as a sun shield and privacy shield.

3. The protection apparatus of claim 1, wherein the said apparatus' smooth front surface can sustain by application, artwork, graphics, advertising, messaging, solicitation, to anyone viewing the deployed said apparatus, whereby the said apparatus can also be utilized to convey a message.

4. The protection apparatus of claim 1, wherein included are graphic visual alerts in predetermined areas on the front surface of the said apparatus whereby a person viewing the apparatus is urged to exercise caution.

5. The protection apparatus of claim 1, wherein included is a means of transforming said apparatus to a plurality of usable smaller units that variably have less surface area than the original article said apparatus.
